(19) United States
(12) Patent Application Publication
(10) Pub. No.: US 2026/0339419 A1
(43) Pub. Date: Oct. 29, 2026

(54) SYSTEM AND METHOD FOR STATISTICAL MANAGEMENT OF LOW POWER MODE SELECTION

(71) Applicant: Samsung Electronics Co., Ltd., Gyeonggi-do (KR)

(72) Inventors: Haobin LUO, Carlsbad, CA (US); Karthik Nagabhushana SANJI, Folsom, CA (US); Yunkyo CHO, Austin, TX (US)

(21) Appl. No.: 19/352,893

(22) Filed: Oct. 8, 2025

Related U.S. Application Data
(60) Provisional application No. 63/790,461, filed on Apr. 17, 2025.

(51) Int. Cl. G06F 1/3296; G06F 1/3228

(52) U.S. Cl. CPC G06F 1/3296; G06F 1/3228

(57) ABSTRACT

A system and a method are disclosed for managing low power mode (LPM) transitions in a processing system, the method comprising detecting at least one idle state of the system over a plurality of timeslots to generate a count of idle timeslots; determining, based on a comparison between the count of idle timeslots and a first threshold value, whether to enter an LPM; and initiating the LPM in response to the count being greater than or equal to the first threshold value.

### CROSS-REFERENCE TO RELATED APPLICATION

This application claims the priority benefit under 35 U.S.C. § 119(e) of U.S. Provisional Application No. 63/790,461, filed on Apr. 17, 2025, the entire contents of which are incorporated herein by reference.

### TECHNICAL FIELD

The present disclosure relates generally to power management in electronic systems. More particularly, the present disclosure pertains to techniques for dynamically selecting low power operating modes in processing systems based on system activity patterns and statistical decision-making.

### SUMMARY

Power management techniques in modern electronic systems often involve placing components into low power modes (LPMs) during idle periods to conserve energy. Conventionally, these transitions are triggered using fixed timeout intervals following inactivity, balancing potential energy savings against the performance and energy overhead of entering and exiting the LPM.

Traditional systems rely on conservative timeout-based policies that attempt to wait long enough to ensure that entering an LPM will be worthwhile (in other words, entering the LPM will provide a net savings of energy). These strategies are often manually tuned and may be inefficient under dynamic or bursty traffic conditions, leading to missed opportunities for power savings or unnecessary wakeup penalties.

One issue with the above approach is that it assumes idle periods follow a predictable pattern, which is rarely the case in real-world workloads. When idle durations vary significantly or exhibit temporal locality, static timeout values either enter LPM too late, forfeiting savings, or too early, incurring wakeup overhead and latency penalties.

To overcome these issues, systems and methods are described herein for dynamically selecting whether to enter an LPM, and which LPM to enter, using statistical evaluation of recent idle history. The disclosed techniques monitor system activity over a rolling window of fixed-length time intervals and apply a statistical hypothesis test, such as a one-tailed Z-test, to estimate the likelihood that the system will remain idle for long enough to benefit from transitioning into a particular LPM. Threshold values for the test statistic are computed based on power and latency characteristics of the system, and may be refined using machine learning techniques or historical data logging. These threshold-based decisions can optionally be augmented by or fallback to conventional timeout-based methods when statistical certainty is low.

The above approaches improve on previous methods because they offer a lightweight, runtime-adaptive solution that accounts for real-time workload variability, improves energy efficiency across a wide range of traffic patterns, and reduces reliance on fixed configuration parameters. The probabilistic modeling approach ensures robustness and scalability, allowing for fine-grained LPM control that maximizes power savings while minimizing latency overhead.

According to an aspect of the disclosure, a method is disclosed for managing LPM transitions in a processing system, the method including detecting at least one idle state of the system over a plurality of timeslots to generate a count of idle timeslots; determining, based on a comparison between the count of idle timeslots and a first threshold value, whether to enter an LPM; and initiating the LPM in response to the count being greater than or equal to the first threshold value.

According to another aspect of the disclosure, a memory device is provided and is configured to manage LPM transitions. The memory device includes a detection unit configured to detect at least one idle state of the memory device over a plurality of timeslots to generate a count of idle timeslots; a comparison unit configured to determine, based on a comparison between the count of idle timeslots and a first threshold value, whether to enter an LPM; and a power management unit configured to initiate the LPM in response to the count being greater than or equal to the first threshold value.

### BRIEF DESCRIPTION OF THE DRAWING

In the following section, the aspects of the subject matter disclosed herein will be described with reference to exemplary embodiments illustrated in the figures, in which:

FIG. 1 illustrates an example architecture of a system for implementing statistical LPM selection in an electronic device, according to an embodiment;

FIG. 2 is a timing diagram illustrating the relationship between power savings of an LPM mode compared to a non-LPM mode, according to an embodiment;

FIG. 3 is a timing diagram illustrating updating the LPM decision log and applying threshold-based mode transitions, according to an embodiment;

FIGS. 4A-4B illustrate a block diagram of an LPM control system, according to an embodiment;

FIG. 5 is a flowchart illustrating dynamic LPM selection and control, according to an embodiment;

FIG. 6 is a flowchart illustrating control flow for managing LPM transitions, according to an embodiment;

FIG. 7 is a flowchart illustrating a method for managing memory traffic in a memory device, according to an embodiment; and

FIG. 8 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), SoC, an assembly, and so forth.

“Idle state,” as used herein, refers to a condition in which a processing system or component is not actively executing tasks, transmitting data, or consuming a limited amount of processing resources. An idle state may be detected when a subsystem or functional block has no pending operations or traffic for a predetermined period of time. Idle states may be used to trigger power-saving transitions, such as entry into an LPM.

“Timeslot,” as used herein, refers to a discrete unit of time used for sampling or evaluating system activity, such as detecting whether a system or component remains idle. A timeslot may correspond to a fixed time interval, such as a duration equal to the entry latency of LPM. A sequence of timeslots may be used to accumulate statistical data regarding system idleness and inform power state decisions.

“Low power mode” or “LPM,” as used herein, refers to an energy-saving operating mode in which one or more components of a processing system are placed into a reduced-power state. Examples of LPM modes include but are not limited to clock gating, power gating/collapse, voltage/frequency scaling, and/or subsystem shutdown. The specific implementation of an LPM may depend on the component type and system architecture. An LPM may be a distinct concept from an idle state. An idle state period or count may be used to determine whether to enter into an LPM. For example, a system may monitor whether a component remains idle over a series of timeslots, and based on the accumulated count of idle timeslots, compare the result to a threshold to decide whether the energy savings from entering an LPM outweigh the transition cost. In this way, the idle state serves as an observable condition, while an LPM is a controlled operational mode activated based on that observation.

“Threshold,” as used herein, refers to a predefined numeric value used as a decision metric for triggering system behavior. In the context of LPM control, a threshold may represent the minimum number of idle timeslots observed within a logging window required to enter an LPM. A system may compare a computed count to one or more thresholds to determine whether to initiate or suppress LPM entry.

In some embodiments, LPM selection may rely on a pre-defined timeout to trigger entry into an LPM. However, this static approach may be generally less effective than entering an LPM immediately upon detecting that the system is idle. On the other hand, immediate entry can lead to unnecessary wakeup penalties if the idle period is short, while waiting for the timeout may result in missed opportunities for power savings. For example, in certain sub-system LPM configurations, delays exceeding ten times the LPM entry time have been observed.

According to an embodiment, a dynamic LPM selection method based on statistical analysis of system idle gaps is provided. This method utilizes a one-tailed Z-test to estimate the likelihood of continued idleness during a given timeslot, allowing the system to determine at runtime whether to enter an LPM and which mode to select. The method (which may be a computer-implemented method, such as an algorithm) is lightweight, with minimal computational cost, and may incorporate a coin-flip model to simulate idle-to-wakeup transitions under the law of large numbers.

An aspect of this approach includes the identification of decision thresholds that indicate when power saving criteria outweigh transition costs. These thresholds can be conservatively estimated to ensure that the method outperforms static timeout strategies under most conditions. Parameters may also be refined using offline machine learning. By logging idle timeslots, intrinsic thresholds can be determined for various LPM modes, offering broad potential for optimization. The statistical foundation of this approach supports high accuracy over time and across diverse activity patterns that exhibit temporal locality.

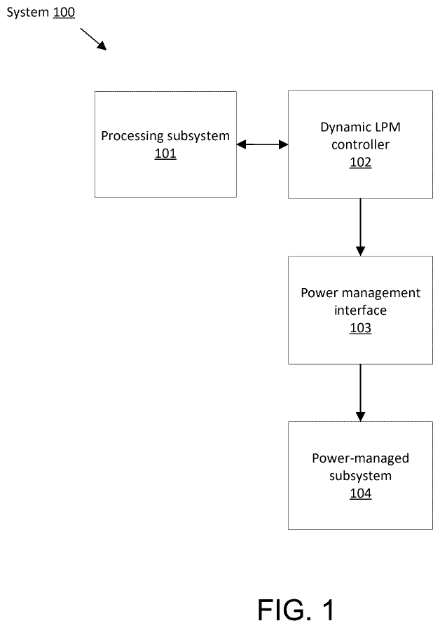

FIG. 1 illustrates an example architecture of a system for implementing statistical LPM selection in an electronic device, according to an embodiment.

Referring to FIG. 1, system 100 includes a processing subsystem 101, a dynamic LPM controller 102, a power management interface 103, and a power-managed subsystem 104. It will be understood that the components illustrated in FIG. 1 are shown for illustrative purposes only and need not be implemented as discrete hardware blocks. Two or more components may be combined into a single hardware block or distributed across multiple modules. The arrangement may vary depending on implementation and should not be viewed as limiting.

Processing subsystem 101 may include one or more processors or circuitry, such as a central processing unit (CPU), graphical processing unit (GPU), image signal processor (ISP), or digital signal processor (DSP). These components may execute workloads that alternate between active and idle phases. When no work is scheduled, the system may become idle, presenting an opportunity to enter an LPM.

Dynamic LPM controller 102 is logically positioned to monitor the activity status of the processing subsystem 101 and make decisions about LPM entry. According to an embodiment, the controller maintains a rolling history of idle timeslots and applies a one-tailed statistical test, such as a Z-test, to estimate the likelihood that the system will remain idle for a sufficient duration. Based on the outcome of the statistical test and associated decision thresholds, the controller may determine whether to initiate an LPM transition and, if applicable, select LPM mode of one or more available LPM modes to enter. The decision logic may be implemented as a dedicated hardware module, as firmware executed by a microcontroller, or as a software task operating within the processing subsystem.

Power management interface 103 serves as a coordination point between the LPM controller 102 and the power-managed subsystem 104. The interface may be responsible for issuing control signals to request LPM entry or exit, and may also communicate relevant power state information, such as LPM entry/exit latencies, energy break-even thresholds, or current mode status. In some embodiments, the interface may expose registers or memory-mapped control fields used to configure the statistical model or update thresholds dynamically.

Power-managed subsystem 104 represents any component or group of components capable of entering one or more LPMs. These may include compute units, memory interfaces, fabric interconnects, or I/O controllers. The subsystem may support multiple LPM states, each with associated energy consumption and wakeup latency characteristics. Upon receiving a control signal from the power management interface 103, subsystem 104 may transition into or out of an appropriate LPM state. In some embodiments, the LPM controller 102 may also track the effectiveness of past decisions by monitoring actual idle durations and wakeup timings, enabling future refinement of statistical thresholds using closed-loop feedback or offline analysis.

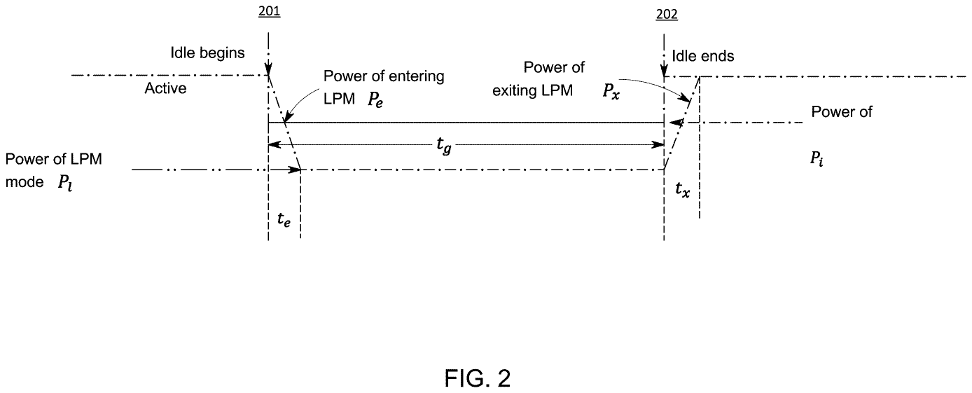

FIG. 2 is a timing diagram illustrating the relationship between power savings of an LPM mode compared to a non-LPM mode, according to an embodiment.

Referring to FIG. 2, in this example, the system begins in an active state and enters an idle state at the point marked “idle begins” 201 and exits the idle state at the point marked “idle ends” 202. During the idle period, the system may choose to enter an LPM state, which consumes a lower steady-state power Pₗ compared to the idle power level Pᵢ if remaining in a non-LPM idle mode. However, the transition into and out of the LPM mode incurs additional power overheads, represented by Pₑ during the entry period tₑ, and Pₓ during the exit period tₓ. The duration of the entire idle period is denoted as t_{g}.

As shown in FIG. 2, these transition costs create a tradeoff between energy savings from reduced steady-state power and energy consumed during mode entry and exit. The system must therefore assess whether the length of the idle period t_{g} is sufficient to justify the use of an LPM. If the idle duration is too short, the transition costs may outweigh the savings. This evaluation underlies the decision framework employed in the present disclosure, which compares predicted idle durations against calculated breakeven thresholds to determine whether initiating an LPM mode is beneficial.

The energy consumed without LPM may be given by t_{g}Pᵢ, while the energy consumed when using LPM may be expressed as tₑPₑ+(t_{g}−tₑ)P_{L}+tₓPₓ. An objective of various embodiments disclosed herein is to determine the condition under which LPM yields net energy savings. This occurs when t_{g} is greater than or equal to a computed threshold T_{g}, which depends on the relative power and timing parameters associated with the transition and steady-state phases of LPM.

A method (algorithm) implementing this decision logic may operate as follows. For each LPM mode, the system defines a rolling window of n timeslots and selects a confidence level, such as 99%, for making LPM decisions. System properties including (Pᵢ Pₗ Pₑ Pₓ tₑ tₓ), along with the selected window size and confidence level, are used to calculate a critical value Th. In real-time, the system maintains a log of the past n timeslots, beginning once the system becomes idle. At each interval of duration tₑ, a value of 1 is logged if the system remained idle throughout the interval, and a value of 0 is logged otherwise. The log is updated continuously by discarding the oldest value once n entries have been recorded (e.g., using a circular buffer).

When the system enters an idle state, the number of is in the log is compared to the threshold Th. If the count meets or exceeds Th, the system may enter a corresponding LPM mode. If the system is already idle in a higher-power state, and the log count still meets or exceeds Th, a transition to the LPM mode may also be performed. A second threshold ThNo may be defined to suppress the LPM entry if the count of is is too low, regardless of timeout expiration. If the count of is falls between Th and ThNo, the system may defer to a traditional timeout mechanism to determine whether LPM entry is appropriate.

When evaluating the effectiveness of the statistical LPM selection method, multiple factors may be considered, including the accuracy of the decision-making method under varying idle patterns. The method may produce one of four possible outcomes depending on whether the idle behavior aligns with the expected threshold-based prediction. In a first type of outcome, the number of recorded idle intervals (i.e., 1 s) exceeds the decision threshold, but the actual idle duration following that decision is shorter than the required threshold T_{g}. This case leads to suboptimal power savings, as the system enters LPM prematurely and incurs more energy overhead than if it had remained idle. In a second type of outcome, the number of is is below the threshold, yet the system subsequently remains idle for a duration greater than T_{g}. This case represents a missed opportunity, as the system fails to enter LPM despite a favorable window.

In contrast, the third outcome occurs when the number of is exceeds the threshold and the system remains idle for a duration longer than T_{g}, resulting in a beneficial power-saving transition into LPM. The fourth outcome involves the number of is being below the threshold and the idle duration remaining short, correctly avoiding a premature entry into LPM. The objective of the algorithm is to maximize the occurrence of the third and fourth cases, while minimizing the first and second, thereby improving both energy efficiency and responsiveness.

The method (algorithm) operates under the assumption of temporal locality in idle patterns, meaning that recent history is predictive of short-term future behavior. However, in practice, the underlying probability distribution may shift abruptly due to changes in workload, usage patterns, or system state. To accommodate such variability, machine learning techniques may be applied to refine or dynamically adjust the threshold values Th and ThNo. By incorporating feedback or statistical training over time, the method may adapt its internal parameters to better track changing patterns and improve its predictive performance in real-world conditions.

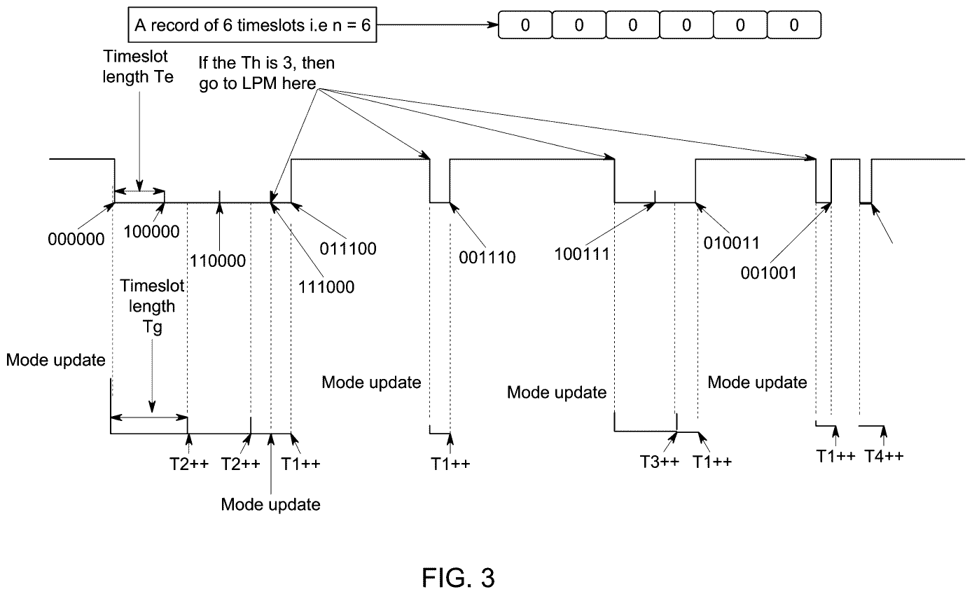

FIG. 3 is a timing diagram illustrating updating the LPM decision log and applying threshold-based mode transitions, according to an embodiment.

Referring to FIG. 3, the system maintains a rolling log of n=6 timeslots, each of fixed duration Tₑ, recording a “1” if the system remains idle throughout the slot, and a “0” otherwise.

As new timeslot results are observed, the log is updated by shifting in the latest result and discarding the oldest. If the number of is in the current log meets or exceeds a threshold Th (e.g., Th=3), the system initiates LPM entry. For example, the log progresses from 000000 to 100000, 110000, and 111000, triggering LPM once the idle count reaches three.

FIG. 3 also shows additional patterns such as 011100 and 100111, which similarly satisfy the threshold. In contrast, a sequence like 000100 does not, and the system remains active. Mode updates (T1++, T2++, etc.) indicate evaluation points for LPM control.

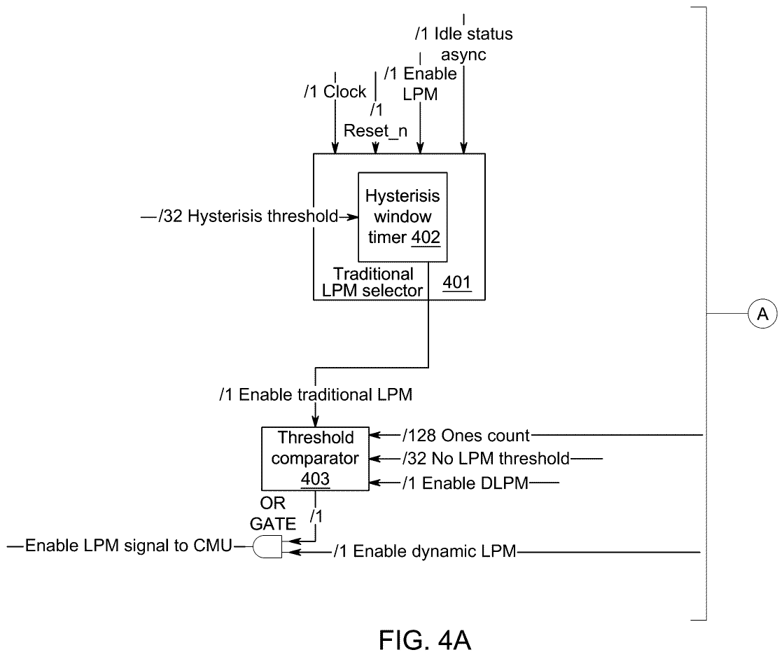

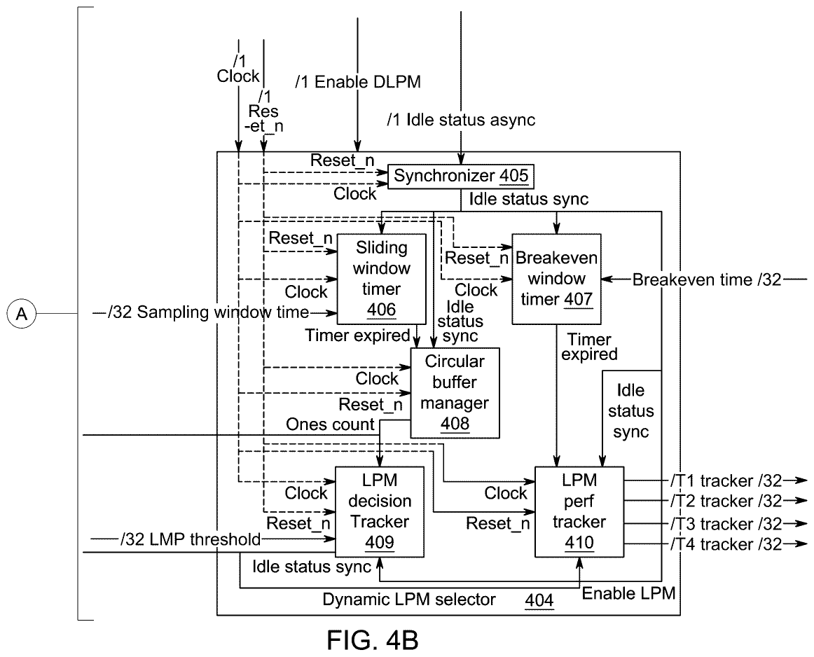

FIGS. 4A-4B illustrate a block diagram of an LPM control system, according to an embodiment. The system integrates threshold-based and history-based decision logic to determine whether and when to enter LPM based on observed idle behavior. FIGS. 4A and 4B are connected at point A, where control signals from the traditional selector 401 are combined with those from the dynamic selector 404 to form a unified block diagram.

Referring to FIG. 4A, a traditional LPM selector 401 includes a hysteresis window timer 402 configured to track idle time based on clock, reset, and enable inputs. The hysteresis window timer 402 receives an idle status signal and compares it against a hysteresis threshold (e.g., 32 cycles) to determine whether a minimum idle time condition has been met. If so, the traditional LPM selector 401 asserts a signal to enable traditional LPM control logic. This output is routed to a threshold comparator 403, which also receives a count of the number of “1”s observed in the recent idle history (e.g., over 128 slots), a configured no-LPM threshold (e.g., 32), and a control signal indicating whether dynamic LPM (DLPM) is enabled.

The threshold comparator 403 outputs a logic signal indicating whether the idle history satisfies the DLPM entry conditions. This signal is logically ORed with the traditional LPM signal using an OR gate to produce the final enable LPM signal to the clock management unit (CMU), ensuring that LPM entry may proceed if either the traditional or dynamic condition is met.

FIG. 4B continues the block diagram of FIG. 4A and shows the dynamic LPM selector 404, which receives control and idle status signals and coordinates multiple timing and decision units. A synchronizer 405 aligns asynchronous idle status signals to the system clock domain to ensure reliable operation. A sliding window timer 406 defines the sampling window, expiring at fixed intervals (e.g., every 32 cycles) to trigger idle history updates. A breakeven window timer 407 similarly tracks whether the observed idle period has met a minimum breakeven time, such that the energy saved by entering LPM would offset the cost of the transition.

A circular buffer manager 408 maintains a log of recent idle status bits corresponding to each sampling window. This rolling log forms the basis for computing the number of idle slots, which is used by the LPM decision tracker 409. The decision tracker 409 compares the number of is in the log against the runtime or precomputed LPM threshold and determines whether the system should enter LPM. The final decision is passed to the output control line “Enable LPM.”

Additionally, the LPM performance tracker 410 maintains runtime statistics for multiple LPM control tracks (T1 through T4), which may correspond to different thresholds, confidence levels, or power states. Each tracker monitors and reports LPM effectiveness, which allows for fine-grained runtime adaptation and diagnostics.

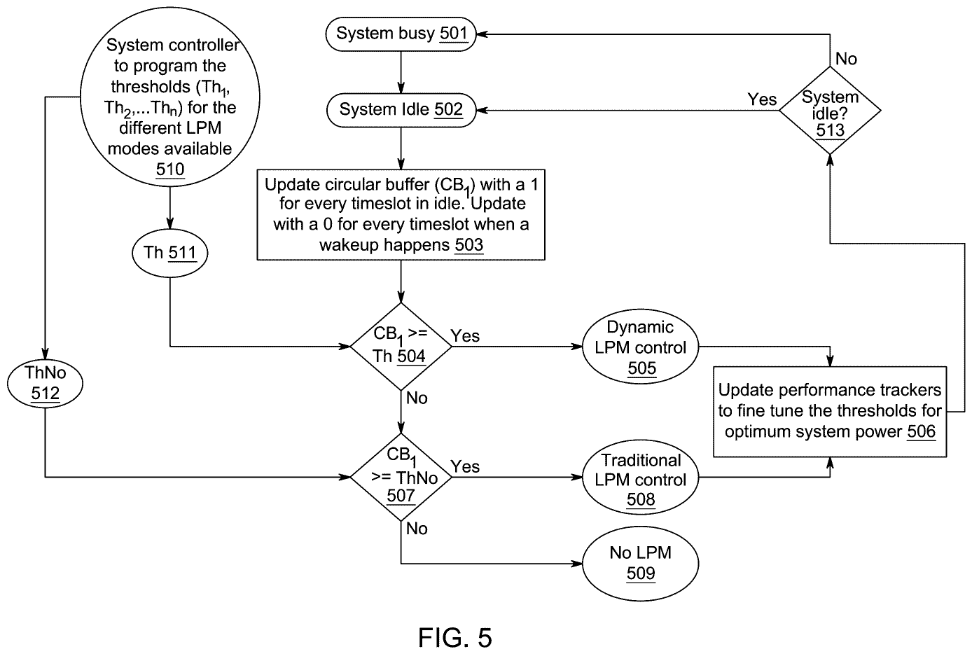

FIG. 5 is a flowchart illustrating dynamic LPM selection and control, according to an embodiment.

Referring to FIG. 5, the process begins when the system is in a busy state 501, and transitions to an idle state 502 when no active processing is occurring.

While idle, the system updates a circular buffer 503 that tracks recent timeslot activity. For each timeslot in which the system remains idle for the full duration, a value of “1” is logged; if a wakeup occurs during the timeslot, a value of “0” is recorded. The number of is in the buffer represents the observed depth of recent idleness.

At decision block 504, the system compares the number of 1s in the buffer (denoted CB₁) to a first threshold Th, which may correspond to a runtime-computed condition based on energy breakeven analysis. If CB₁ is greater than or equal to Th, the system initiates dynamic LPM control 505. This enables entry into a selected LPM mode based on a statistical prediction of continued idleness. After entering dynamic LPM, the system updates performance trackers 506, which log metrics used to refine the thresholds and improve energy savings over time.

If CB₁ does not meet the Th threshold at block 504, a secondary decision is made at block 507, comparing CB₁ to a second, more conservative threshold ThNo. If CB₁ is greater than or equal to ThNo, the system falls back to traditional LPM control 508, which may use fixed timeouts or simpler heuristics to trigger LPM entry. If neither threshold is satisfied, the system refrains from entering LPM and remains in an active idle mode 509.

The thresholds Th and ThNo may be configured by system's controller 510, which sets a range of values (Th₁, Th₂, . . . Thₙ) corresponding to various LPM configurations.

These values are loaded into the system and applied at runtime via logic block 511 for Th and block 512 for ThNo. During each idle opportunity, the system checks the current idle status 513. If the system is no longer idle, control returns to the top of the flow to resume busy operation 501.

This flowchart reflects the interaction of runtime idle monitoring, history-based thresholding, and multi-mode LPM control logic, which together enable adaptive and energy-efficient power management decisions tailored to observed workload behavior.

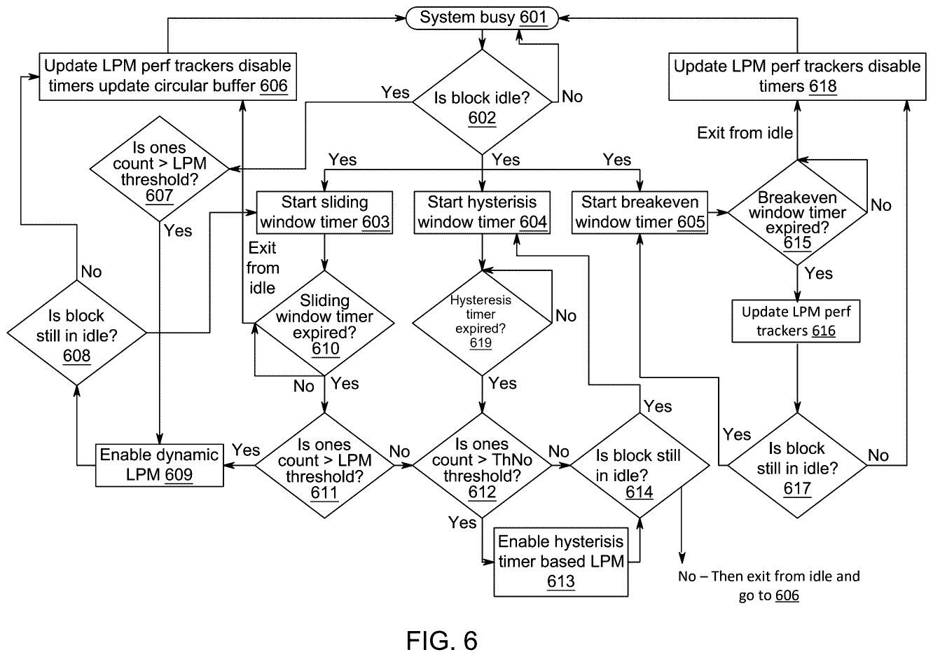

FIG. 6 is a flowchart illustrating control flow for managing LPM transitions, according to an embodiment.

Referring to FIG. 6, the process begins in a system busy state 601, where no LPM action is taken. When an idle condition is detected in block 602, the system initiates parallel evaluations by starting multiple timers.

If the block is idle, a sliding window timer 603, a hysteresis window timer 604, and a breakeven window timer 605 are started simultaneously. These timers serve to determine whether the system has remained idle long enough to justify entering LPM under different criteria.

At the same or similar times (e.g., in parallel), a background update procedure 606 logs the current idle status into a circular buffer, disables previous timers, and updates performance trackers used to evaluate the efficiency of past LPM decisions. The buffer maintains a record of recent timeslot activity to track how many times the system remained idle for a full interval.

If the number of is in the circular buffer exceeds a configurable LPM threshold in decision block 607, and the block is still idle in block 608, the system proceeds to enable dynamic LPM in block 609. If the threshold is not met, the system loops back and continues monitoring.

Separately, the expiration of the sliding window timer 610 triggers another check of the idle log. If the number of idle timeslots still exceeds the LPM threshold in block 611, dynamic LPM is enabled in block 609. If the threshold is not met, the system checks whether it meets a ThNo threshold in block 612. If this lower threshold is met, the system enables hysteresis timer-based LPM in block 613. If neither threshold is satisfied, the system checks if the block is still idle in 614, and if so, returns to block 604. If the block is not idle in 614, the process proceeds to block 606, and the system exits from idle.

At the same or similar times (e.g., in parallel), the hysteresis window timer 604 monitors whether the system has remained idle long enough to meet a fixed-duration minimum threshold. When the hysteresis timer expires in block 619, the system checks if the idle history satisfies the ThNo threshold in block 612. If so, hysteresis-based LPM is enabled at 613.

At the same or similar times (e.g., in parallel), the breakeven window timer 605 monitors whether sufficient idle time has accumulated. Once this timer expires in block 615, the system updates the LPM performance trackers at block 616. If the block is still idle in 617, the system continues to track this extended idle period. Otherwise, it returns to the busy state at 601 and updates performance data accordingly at block 618.

This control logic allows the system to evaluate multiple LPM entry strategies simultaneously based on dynamic thresholds, hysteresis delays, and breakeven time and select the most appropriate LPM strategy based on runtime conditions.

Further details corresponding to the foregoing embodiments are described below.

According to an embodiment, system idle and wakeup behavior may be modeled as a process resembling a sequence of coin flips. When the system enters an idle state (i.e., when there is no active data being processed) a measurement begins to track how long the system remains idle. Rather than measuring this duration in absolute time, the system quantizes idle duration into discrete timeslots, where each timeslot has a fixed length tₑ, corresponding to the latency required to enter the applicable LPM as previously described. The total number of timeslots observed during an idle period may be denoted by n, where n is equal to

$$\frac{{t}_{g}}{{t}_{e}} ,$$

and n is less than 1, then it is set to 0.

For each timeslot, a binary value is recorded: a value of 1 if the system remains idle for the full duration of the slot, or a value of 0 if the system exits idle at any point during the slot. If the system enters and exits idle within the same slot, that timeslot is also recorded as 0. To capture the uncertainty of the exact wakeup point within a timeslot, a random variable a may be introduced to represent the fraction of the timeslot during which the system remained idle prior to wake up. Due to the difficulty in directly estimating the probability distribution of idle durations over arbitrary time intervals, the system instead models the likelihood of remaining idle for one more timeslot using a coin-flip metaphor, where each slot represents an independent Bernoulli trial with a fixed probability of continued idleness.

In some embodiments, this process may be further applied as a Markov chain, which assumes the memoryless property: the probability of remaining idle in the next timeslot is independent of the prior history of idle or active periods. This approach simplifies modeling by treating each transition as probabilistically independent, much like a fair or biased coin toss. For more refined modeling, a Markov Chain Monte Carlo (MCMC) framework may be employed. In such cases, an initial sequence estimator may be used to determine the appropriate sample size required to estimate the expected number of idle slots (i.e., the average idle gap time) with a specified confidence level.

The system may determine whether to enter the LPM by evaluating whether t_{g} is greater than or equal to

$$\frac{{t}_{e} ( {P}_{e} - {P}_{L} ) + {t}_{x} {P}_{x}}{{P}_{i} - {P}_{L}} ,$$

and whether

$$\frac{{t}_{e} ( {P}_{e} - {P}_{L} ) + {t}_{x} {P}_{x}}{{P}_{i} - {P}_{L}}$$

is equal to T_{g}. If this condition is met, indicating that the projected energy savings outweigh the transition costs, then the system may initiate entry into the designated LPM mode.

According to an embodiment, the calculation of the threshold Th is based on at least two principles. First, probability theory is used to determine the condition under which the algorithm, when applied over time, yields energy savings relative to remaining in the idle mode without transitioning to the designated LPM. Second, the analysis seeks to identify the minimum probability of remaining idle over the next tₑ interval that is required for the system to achieve a net energy benefit, on average, from entering the LPM state. This condition may be formulated using the expected value of a random variable, expressed in probability theory according to Equation 1:

E(f(X))=Σf(X)P(X) Equation 1

where X denotes a set of non-overlapping idle/wakeup scenarios, f(X) is the energy consumed under the LPM transition for each scenario, and P(X) is the probability of occurrence for that scenario. The expectation E(f(X)) is compared against the energy consumed by not entering LPM during idle, with the goal of maintaining the expected energy lower than that of the non-LPM path.

This probabilistic analysis yields a target value, denoted as ρ₀, which represents the minimum probability of continued idleness needed for LPM to be beneficial, given the system-specific parameters including (Pᵢ Pₗ Pₑ Pₓ tₑ tₓ). Once po is determined, a statistical hypothesis test such as a Z-test may be applied to compute the corresponding threshold Th. The value of Th depends on po, the desired confidence level for the LPM decision, and the sample size n of the idle slot history maintained by the algorithm. The Z-test provides a mechanism for determining the minimum number of idle slots required within the rolling window to justify an LPM transition with statistical confidence.

An aspect of the threshold calculation may involve identifying all possible idle-to-wakeup scenarios, the corresponding energy consumption for each scenario, and the probability of occurrence for each. In this case, once the system enters the idle state, the timing of the next wakeup event is treated as a non-deterministic variable. By defining n as the number of timeslots the system remains idle, each possible value of n corresponds to a unique scenario. The full set of scenarios thus spans all non-negative integers. A lookup table or analytical function, such as Table 1, below, may be used to associate each scenario with a corresponding energy value when the LPM mode is selected, as well as the energy consumed in the standard idle mode.

TABLE 1

| Number | | Probability | Energy of normal |
|---|---|---|---|
| of slots | Energy if | of the scenario | idle mode if no |
| in idle | LPM is entered | happens | LPM is chosen |
| 0 | Eₑ + Eₓ | 1-p | αEᵢ |
| 1 | Eₑ + αEₗ + Eₓ | p(1 -p) | Eᵢ + αEᵢ |
| 2 | Eₑ + Eₗ + Eₓ + αEₗ | p² (1 - p) | 2Eᵢ + αEᵢ |
| n | Eₑ + (n - 1)Eₗ + Eₓ + αEₗ | pⁿ (1 - p) | nEᵢ + αEᵢ |

The parameter a represents a fractional random variable capturing partial idle occupancy during a timeslot in which the wakeup occurs.

Individual energy terms may be defined as follows: Eₑ=tₑPₑ may represent the energy consumed during LPM entry, Eₓ=tₓPₓ for LPM exit, Eₗ=tₑPₗ for steady-state LPM energy per timeslot, and Eᵢ=tₑPᵢ for idle energy per timeslot when LPM is not entered. The mean energy consumed when entering LPM, denoted TotalE, may be expressed as a weighted sum of scenario outcomes, using Equation 2:

$$TotalE = ( 1 - p ) ( {E}_{e} + {E}_{x} ) + {\sum }_{n = 1}^{∞} ( ( 1 - p ) {p}^{n} ( {E}_{e} + {E}_{x} + ( n - 1 ) {E}_{l} + α {E}_{l} ) \qquad Equation 2$$

By defining E_{d}=Eₑ+Ex, the expression simplifies to Equation 3:

$$TotalE = ( 1 - p ) ( {E}_{d} + {\sum }_{n = 1}^{∞} ( {p}^{n} ( {E}_{d} + ( n - 1 ) {E}_{l} + α {E}_{l} ) ) ) \qquad Equation 3$$

By comparison, the expected energy consumed when staying in idle without entering LPM, denoted TotalENormal, may be given by Equation 4:

$$TotalENormal = ( 1 - p ) {\sum }_{n = 0}^{∞} {p}^{n} ( {nE}_{i} + α {E}_{i} ) \qquad Equation 4$$

The condition under which entering LPM yields energy savings can thus be formulated as TotalE<TotalENormal, or more precisely given by the inequality in Equation 5:

$$( 1 - p ) ( {E}_{d} + {\sum }_{n = 1}^{∞} ( {p}^{n} ( {E}_{d} + ( n - 1 ) {E}_{l} + α {E}_{l} ) ) ) < ( 1 - p ) {\sum }_{n = 0}^{∞} {p}^{n} ( {nE}_{i} + α {E}_{i} ) \qquad Equation 5$$

Solving this inequality enables the determination of the breakeven probability p above which LPM entry is expected to result in reduced energy consumption over time.

In some embodiments, solving the energy comparison inequality may be complicated by the presence of the random variable u, which reflects the fractional portion of time spent idle within the final timeslot before wakeup. To simplify the analysis, a may be approximated as an unknown value a in the range from 0 to 1. Substituting this approximation into the inequality allows for algebraic manipulation of both sides. The left-hand side of Equation 5, representing the expected energy when entering LPM, becomes Equation 6:

$${E}_{d} + {\sum }_{n = 1}^{∞} ( {p}^{n} ( {E}_{d} + ( n - 1 ) {E}_{l} + {aE}_{l} ) ) = {E}_{d} + {\sum }_{n = 1}^{∞} {p}^{n} {E}_{d} + {\sum }_{n = 1}^{∞} {p}^{n} ( n - 1 ) {E}_{l} + a {\sum }_{n = 1}^{∞} {p}^{n} {E}_{l} = {E}_{d} + \frac{p}{1 - p} {E}_{d} + \frac{{p}^{2}}{{( 1 - p )}^{2}} {E}_{l} + a \frac{p}{1 - p} {E}_{l} = \frac{1}{1 - p} {E}_{d} + \frac{{p}^{2}}{{( 1 - p )}^{2}} {E}_{l} + a \frac{p}{1 - p} {E}_{l} \qquad Equation 6$$

Similarly, the right-hand side of Equation 5, representing the expected energy when remaining in the idle mode, becomes Equation 7:

$${\sum }_{n = 0}^{∞} {p}^{n} ( {nE}_{i} + {aE}_{i} ) = \frac{p}{{( 1 - p )}^{2}} {E}_{i} + a \frac{1}{1 - p} {E}_{i} \qquad Equation 7$$

The inequality TotalE<TotalENormal thus reduces to Equation 8:

$$\frac{1}{1 - p} {E}_{d} + \frac{{p}^{2}}{{( 1 - p )}^{2}} {E}_{l} + a \frac{p}{1 - p} {E}_{l} < \frac{p}{{( 1 - p )}^{2}} {E}_{i} + a \frac{1}{1 - p} {E}_{i} \qquad Equation 8$$

After rearrangement and simplification, this inequality in Equation 8 may be written as Equation 9:

p²(Eᵢ−aEₗ)−p(Eᵢ+E_{d}−aEₗ−aEᵢ)+E_{d}−aEᵢ≤0 Equation 9

This is a quadratic inequality in p, and its solution provides the minimum probability p required for entering LPM to be energetically beneficial. The range of solutions can be bounded by evaluating the inequality for edge cases a=0 and a=1. When a=0, the expression simplifies to Equation 10:

p²Eₗ−p(Eᵢ+E_{d})+E_{d}≤0 Equation 10
which yields a solution of Equation 11:

$$p \geq \frac{{E}_{i} + {E}_{d} - \sqrt{{( {E}_{i} + {E}_{d} )}^{2} - 4 {E}_{l} {E}_{d}}}{2 {E}_{l}} \qquad Equation 11$$

When a=1, the inequality of Equation 9 becomes Equation 12:

$$p \geq \frac{{E}_{d} - {E}_{i}}{{E}_{d} - {E}_{l}} \qquad Equation 12$$

If E_{d}>Eₗ, the solution may be less than zero, which is not physically meaningful. However, when both results are valid, the maximum of the two expressions may be selected as the conservative threshold ρ₀ as shown in Equation 13:

$$ρ 0 = max ( \frac{{E}_{i} + {E}_{d} - \sqrt{{( {E}_{i} + {E}_{d} )}^{2} - 4 {E}_{l} {E}_{d}}}{2 {E}_{l}} , \frac{{E}_{d} - {E}_{i}}{{E}_{d} - {E}_{l}} ) \qquad Equation 14$$

Alternatively, a more conservative simplification may be used by substituting α=1 on the left side and α=0 on the right side of Equation 5. In that case, the inequality simplifies to Equation 15:

$${E}_{d} + \frac{{p}^{2}}{( 1 - p )} {E}_{l} + {pE}_{l} < \frac{p}{( 1 - p )} {E}_{i} \qquad Equation 15$$

Which further reduces to Equation 16:

−p(Eᵢ+E_{d}−Eₗ)+E_{d}≤0 Equation 16

Solving Equation 16 yields Equation 17:

$$p \geq \frac{{E}_{d}}{{E}_{i} + {E}_{d} - {E}_{l}} = {ρ}_{0} \qquad Equation 17$$

This value may be used as the most conservative estimate of po. Since Eᵢ>Eₗ under normal conditions (i.e., LPM consumes less power than idle), this formulation ensures that ρ₀ is less than 1, making it a valid and usable threshold for the decision model.

Accordingly, the threshold Th balances the probabilistic expectation of energy savings with the system's risk tolerance and response latency.

Alternatively, the threshold po may be determined by analyzing the condition under which the long-term mean idle time exceeds the LPM breakeven threshold T_{g}. For a given probability p, representing the likelihood of the system remaining idle for one additional timeslot, the expected idle duration can be expressed in terms of the number of timeslots.

Specifically, the expected idle time in units of tₑ may be modeled as the mean of a geometric-like series weighted by fractional coefficients. This expectation may be given as Equation 18:

Mean(idle time in number of tₑ)=Mean(((1−p)(a₀+(a₁+1)p+(a₂+2)p²+ . . . +(aₙ+n)pⁿ+ . . . )) Equation 18

where a₀, a₁, . . . aₙ represent a sequence of identically distributed random variables with mean value u, capturing fractional timeslot occupancy in each wakeup event. This series simplifies to a closed-form expression for the mean idle duration, given by Equation 19:

$$Mean idle time = \frac{p}{1 - p} + α \qquad Equation 19$$

This expression represents the average number of full timeslots that the system is expected to remain idle, augmented by the partial slot represented by a. To ensure that entering the LPM mode results in net energy savings, this mean idle duration must exceed the breakeven time T_{g} divided by the slot length tₑ. Thus, the condition becomes Equation 20:

$$\frac{p}{1 - p} + α > \frac{{T}_{g}}{{T}_{e}} \qquad Equation 20$$

Solving this inequality for p yields a minimum threshold po, which defines the probability of continued idleness required to satisfy the LPM entry condition as shown in Equation 21:

$$p > {ρ}_{0} = \frac{\frac{{T}_{g}}{{T}_{e}} - α}{\frac{{T}_{g}}{{T}_{e}} + 1 - α} \qquad Equation 21$$

Additionally, the value of a may have a significant role in determining the threshold probability ρ₀, and thus directly impact the calculation of the decision thresholds Th and ThNo. Empirical data collected from large-scale real-world systems may suggest a typically ranges from 0.1 to 0.5, depending on both the system's traffic pattern and the length of the timeslot tₑ, which corresponds to the entry latency for the LPM. In some configurations, a default value of α=0.2 may be used for initialization. It is noted that smaller values of tₑ, which represent quicker LPM entry times, are generally associated with larger values of α, reflecting a greater probability that wakeup will occur mid-slot. This, in turn, this leads to a smaller value of ρ₀, and therefore a lower value of Th, resulting in a more permissive condition for entering LPM mode.

In real-time operation, a controller executing instructions may dynamically calculate or refine the value of a using runtime data. For example, the system timer value at the moment of each wakeup event can be sampled and logged over a defined number of wakeup intervals. Based on this log, an updated average for a may be determined and used to recalculate Th and ThNo at runtime.

Additionally, the act of entering and exiting LPM may introduce latency into the system, which can impact the timing of request processing and, consequently, alter the observed traffic pattern. For instance, if a queueing model with arrival rate, and service rate p is considered, the insertion of a fixed delay d to the service time of the first request after an idle period effectively modifies the behavior of the queue. This structural change may influence both system performance and the effectiveness of LPM decisions, and may optionally be accounted for in the runtime adjustment of thresholds or feedback-based tuning mechanisms.

Queueing theory can be used to further refine the energy-saving model by accounting for the effect of added latency due to wake up from LPM. In some queueing models, the traffic intensity is given by Equation 22:

$$ρ = \frac{λ}{μ} \qquad Equation 22$$

where λ is the arrival rate of requests and p is the service rate.

The probability that the system is idle is given by Equation 23:

P₀=1−ρ Equation 23

Since the service rate p is equal to the inverse of the average service time E(S), S is defined as the average service time without added LPM wakeup delay. If a fixed delay d is introduced only for the first request after an idle period, the effective average service time becomes Equation 24:

S_{avg}=P₀(S+d)+(1−P₀)S=(1−ρ)(S+d)+ρS=S+(1−φd Equation 24

Accordingly, the effective traffic intensity becomes Equation 25:

ρ_{effective}=λ(S+(1−ρ)d)=ρ+λ(1−ρ)d Equation 25

The revised proportion of time that the system spends in the idle state is then given by Equation 26:

P_{idle}=1−ρ_{effective}=(1−p)(1−λd)=(1−ρ)(1−ρμd) Equation 26

This formulation imposes a constraint on allowable traffic intensity. If μd≥1, then the condition

$$ρ ∈ ( 0 , \frac{1}{μ d} )$$

must hold. If μd<1, then ρ∈(0, 1), which is a standard unconstrained case. From this, a lower bound condition on the idle probability can be derived by Equation 27:

$${P}_{0} \geq 1 - \frac{1}{μ d} \qquad Equation 27$$

This leads to an additional constraint for the statistical LPM threshold, indicating that the calculated value of ρ₀ should satisfy Equation 28:

$${ρ}_{0} > 1 - \frac{1}{μ d} , if μ d < 1 \qquad Equation 28$$

This constraint ensures that the LPM transition logic does not result in excessive queuing latency or traffic buildup.

When applying the LPM decision logic to a specific block or subsystem, the nature of the traffic workload should be considered. For scenarios involving bursty traffic, it may be appropriate to apply the analysis over the entire burst interval. If the average burst length is N, then the effective service delay per request in the burst may be reduced to d/N.

In such cases, the constraint on po may be refined as Equation 29:

$${ρ}_{0} > 1 - \frac{1}{( \frac{μ d}{N} )} , if \frac{μ d}{N} < 1 \qquad Equation 29$$

Accordingly, this adjustment accounts for the amortized impact of LPM wakeup delay across multiple requests in a burst to ensure that control logic is responsive to workload characteristics and preserves the intended energy savings.

With the value of ρ₀ calculated, and given a logging window size n and a desired confidence level, the threshold Th can be determined using a Z-test. The system may use this test to assess whether the probability of remaining idle for the next tₑ interval exceeds ρ₀.

The threshold is given according to Equation 30:

Th=n̅(̅Z̅₀̅s̅+̅ρ̅₀̅)̅ Equation 30

where

$$s = \sqrt{\frac{{ρ}_{0} ( 1 - {ρ}_{0} )}{n}} ,$$

and Z₀ is the Z-score corresponding to the desired confidence level (e.g., 2.33 for 99%). The ceiling function ensures an integer value.

This threshold defines the minimum number of idle slots in the log needed to trigger entry into the LPM.

To perform a Z-test when a test statistic T is approximately normally distributed under the null hypothesis, the expected value ρ₀ and the standard deviation s of T must first be estimated. In this context, the standard deviation is calculated according to Equation 31:

$$s = \sqrt{\frac{{ρ}_{0} ( 1 - {ρ}_{0} )}{n}} \qquad Equation 31$$

where n is the sample size. The Z-test evaluates the null hypothesis H₀≤ρ₀ against the alternative hypothesis H₀:p≤ρ₀, forming a one-tailed (right-tailed) test.

The calculated score is computed using Equation 32:

$$Z = \frac{\overline{x} - {ρ}_{0}}{s} \qquad Equation 32$$

where

$$\overline{x} = \frac{number of heads}{sample size}$$

is the observed fraction of idle slots in the sample window. For example, using a 99% confidence level, the Z-value threshold Z₀ is 2.33. The condition for accepting the alternative hypothesis becomes x̅≥Z₀s+ρ₀, which implies that the number of is in the log must meet or exceed n(Z₀s+ρ₀). When this threshold is met, the system may enter the LPM state with high confidence that doing so will result in energy savings.

While a 99% confidence level provides conservative behavior, more aggressive configurations using lower confidence thresholds may yield higher long-term power savings. The threshold Th may be adjusted accordingly to tune the trade-off between decision certainty and energy efficiency.

Before proceeding with power gain estimation based on the selected threshold Th, it may be useful to clarify a common misconception about the Z-test. As mentioned above, Th was calculated using Equation 30, where Z₀ is the Z-score corresponding to a desired confidence level. For example, a 95% confidence level corresponds to Z₀≈1.65, which implies a p-value of 0.05. This p-value represents the probability of observing the measured data (or more extreme data) assuming the null hypothesis H₀ is true, that is, P(data|H₁).

However, in practice, the probability that the alternative hypothesis H₁ is true given the observed data is carefully considered, or P(H1|data). Using Bayes' theorem, this can be expressed as Equation 33:

$$P ( H 1 \vert data ) = \frac{P ( data \vert {H}_{1} ) P ( {H}_{1} )}{P ( data )} \qquad Equation 33$$

where P(H₁) is the prior probability that H₁ is true and P(data) is the total probability of observing the data. This distinction highlights that while the Z-test provides statistical significance under H₀, estimating long-term power gain from entering LPM is better guided by Bayesian interpretation when refining Th for practical deployment.

Estimating the posterior probability P(data|H1) is described below. In Bayesian statistical modeling, particularly for binary outcomes such as idle-versus-wakeup events, the Beta distribution may be used as both the prior and posterior. To fine-tune the threshold Th, a uniform, non-informative prior distribution, is provided as p~Beta(1,1).

In addition, the baseline threshold po is defined as the maximum of two constraints, chosen to ensure energy-saving conditions are met according to Equation 34:

$${ρ}_{0 =} max ( 1 - \frac{1}{\frac{μ {T}_{x}}{N}} , \frac{\frac{{T}_{g}}{{T}_{e}} - α}{\frac{{T}_{g}}{{T}_{e}} + 1 - α} ) \qquad Equation 34$$

For each candidate threshold k, where k represents the number of is in a logging window of size n, the posterior distribution becomes p|data~Beta(1+k, 1+n−k).

This posterior distribution is denoted fₖ(p). Based on this, the probability that p exceeds po is given by Equation 35:

$${P}_{k} ( p > {ρ}_{0} ) = {\int }_{{ρ}_{0}}^{1} {f}_{k} ( p ) dp \qquad Equation 35$$

Accordingly, in this case, given the observed data, that the system is likely to remain idle long enough to enter into an LPM. The conditional mean of p under the assumption that H₁ is true is given by Equation 36:

$${p}_{k}^{H 1} = \frac{{\int }_{{ρ}_{0}}^{1} {pf}_{k} ( p ) dp}{{P}_{k} ( p > {ρ}_{0} )} \qquad Equation 36$$

Similarly, the probability that p po is given by Equation 37:

Pₖ(P≤ρ₀)=1−Pₖ(p>π₀) Equation 37

The corresponding conditional expectation is given by Equation 38:

$${p}_{k}^{H 0} = \frac{{\int }_{0}^{{ρ}_{0}} {pf}_{k} ( p ) dp}{{P}_{k} ( p \leq {ρ}_{0} )} \qquad Equation 38$$

If the computed

$${p}_{k}^{H 0}$$

exceeds the earlier bound

$$\frac{\frac{{T}_{g}}{{T}_{e}} - α}{\frac{{T}_{g}}{{T}_{e}} + 1 - α} ,$$

it is capped to that maximum value to avoid overestimating the expected idle time under H₁.

Using these values, the expected number of idle slots is computed as Equation 39-40:

$${E}_{k} [ time slots \vert p = {p}_{k}^{H 1} ] = \frac{1}{1 - {p}_{k}^{H 1}} \qquad Equation 39$$

this represents the average idle time in number of Tₑ slots when H₁ is true.

$${E}_{k} [ time slots \vert p = {p}_{k}^{H 0} ] = \frac{1}{1 - {p}_{k}^{H 0}} \qquad Equation 40$$

this represents the average idle time in number of Tₑ slots when H₀ is true.

The expected energy difference for each k is then calculated as Equation 41:

$${E}_{k} ( Enerfy diff ) = ( {E}_{i} - {E}_{l} ) ( {P}_{k} ( p \leq {ρ}_{0} ) ( {E}_{k} [ time slots \vert p = {p}_{k}^{H 0} ] - 1 ) + {P}_{k} ( p > {ρ}_{0} ) ( ( {E}_{k} [ time slots \vert p = {p}_{k}^{H 1} ] - 1 ) - {E}_{d} ) \qquad Equation 41$$

The threshold Th is defined as the smallest value of k for which the energy difference becomes positive. This approach identifies the most aggressive threshold that still guarantees net energy savings. The corresponding values Pₖ(p>ρ₀),

$${p}_{k}^{H 1} and {p}_{k}^{H 0}$$

may also be retained as posterior estimates and used for runtime control or adaptive tuning. These may be denoted respectively as P_{H1}, p^{H1}, and p^{H0}.

To evaluate how the statistical scheme compares with a fixed-timeout LPM entry method, the expected energy equations may be simplified by limiting the summation window to a finite number N of timeslots. This effectively models a fixed timeout approach that waits N idle slots before initiating LPM entry. Under this model, the energy consumed when using the fixed timeout strategy can be expressed according to Equation 42:

$${E}_{d} + {\sum }_{n = 1}^{N} {p}^{n} {E}_{d} + {\sum }_{n = 1}^{N} {p}^{n} ( n - 1 ) {E}_{l} + {\sum }_{n = 1}^{N} {p}^{n} {E}_{l} = {\sum }_{n = 0}^{N} {p}^{n} {nE}_{i} \qquad Equation 42$$

In Equation 42, the left-hand side accumulates the LPM entry cost E_{d}, the cumulative LPM energy over N slots, and the cost of delayed LPM entry. The right-hand side models the energy used when staying in idle mode throughout the timeout window. After algebraic simplification and truncating the infinite tail, the expression becomes Equation 43:

$${E}_{d} + {E}_{d} p \frac{( 1 - {p}^{N} )}{1 - p} + {E}_{l} {p}^{2} \frac{1 - {p}^{N}}{{( 1 - p )}^{2}} + {E}_{l} p \frac{1 - {p}^{N}}{1 - p} = {E}_{i} p \frac{1 - {p}^{N}}{{( 1 - p )}^{2}} + {E}_{d} {p}^{N} \qquad Equation 43$$

Solving for equality between LPM and idle-only energy yields Equation 44:

$${E}_{d} + {E}_{l} \frac{p}{1 - p} = {E}_{i} \frac{p}{1 - p} \qquad Equation 44$$

which leads to Equation 45:

$$\frac{{E}_{d}}{{E}_{i} + {E}_{d} - {E}_{l}} = {ρ}_{0} \qquad Equation 45$$

This implies that whenever the estimated probability of continued idleness p meets or exceeds po, the statistical LPM decision will outperform the fixed timeout method, regardless of the specific timeout value used. Thus, if the system has high confidence that p≥ρ₀, it should immediately enter LPM. The remaining question concerns whether abstaining from LPM when confidence is low (i.e., p<ρ₀) would still outperform the timeout method.

To handle this case, the same Z-test framework may be applied in reverse to test the null hypothesis H₀:p≥ρ₀ against the alternative H₁: p<ρ₀. A left-tailed Z-test may be used to define a second threshold ThNo, below which the system should explicitly avoid LPM entry, even if the timeout expires. The threshold is calculated as Equation 45:

ThNo=n(ρ₀−Z₀s) Equation 45

If the number of observed idle slots is less than ThNo, the system concludes that p<ρ₀ with high confidence and refrains from entering LPM. When the number of is in the log falls between ThNo and the main threshold Th, the system may fall back to the traditional timeout mechanism. This hybrid policy ensures that LPM entry occurs when it is statistically favorable and falls back to the timeout method in uncertain cases.

To evaluate the impact of LPM latency on overall system performance, the traffic and processing behavior may be modeled as a G/G/1 queue. According to the Marchal approximation, the average queue length L_{q} for such a system can be estimated using Equation 46:

$${L}_{q} \approx \frac{{ρ}^{2} ( 1 + {C}_{s}^{2} ) ( {C}_{a}^{2} + {ρ}^{2} {C}_{s}^{2} )}{2 ( 1 - ρ ) ( 1 + {ρ}^{2} {C}_{s}^{2} )} \qquad Equation 46$$

Here, ρ represents the system utilization, defined as Equation 47:

ρ=λ(PT₁+(1−P)T₂) Equation 47

where λ is the average request arrival rate, P is the probability that an arriving request finds the system idle (i.e., no queue), T₁ is the average service time for the first request after an idle period (which may include LPM wakeup latency), and T₂ is the average service time for subsequent requests. The terms

$${C}_{a}^{2} and {C}_{s}^{2}$$

denote the squared coefficients of variation for interarrival and service times, respectively, given by Equations 48 and 49:

$${C}_{a}^{2} = {( λ {σ}_{a} )}^{2} \qquad Equation 48$$

$${C}_{s}^{2} = {( μ {σ}_{s} )}^{2} \qquad Equation 49$$

where σₐ and σₛ are the standard deviations of the interarrival and service time distributions, and μ is the average service rate (i.e., the inverse of service time). The average queueing delay per request may then be approximated as L_{q}/λ.

When LPM wakeup latency is introduced, an additional delay T may be added to the service time of the first request after an idle interval. For general distributions of arrival and service patterns, closed-form analytical results may not be available, but the above formula provides a useful approximation for estimating the impact of LPM transitions on system latency in real time.

In addition, when the arrival rate is below system capacity (i.e., p<1), the additional delay introduced by LPM wakeup is typically bounded by T for each affected request.

Thus, under stable traffic conditions, the added latency attributable to LPM decisions may remain manageable and without exceeding the wakeup penalty per request.

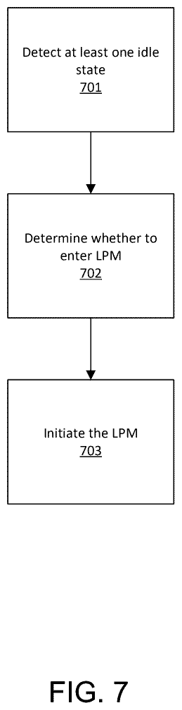

FIG. 7 is a flowchart illustrating a method for managing memory traffic in a memory device, according to an embodiment.

Referring to FIG. 7, at step 701, the processing system detects at least one idle state over a plurality of timeslots and, for each timeslot, records whether the system remained idle, thereby generating a running count of idle timeslots. For example, a memory controller may sample request queues at a fixed interval and increment the count when no read/write activity occurs for the full interval.

At step 702, the system determines whether to enter an LPM by comparing the current count of idle timeslots against a first threshold value. The comparison may use the count accumulated from step 701 and a preconfigured threshold corresponding to conditions under which LPM will provide net benefit.

At step 703, in response to the count being greater than or equal to the first threshold value, the system initiates the LPM. For example, control then returns to step 701 upon exit from LPM to resume monitoring and repeat the method during subsequent idle opportunities.

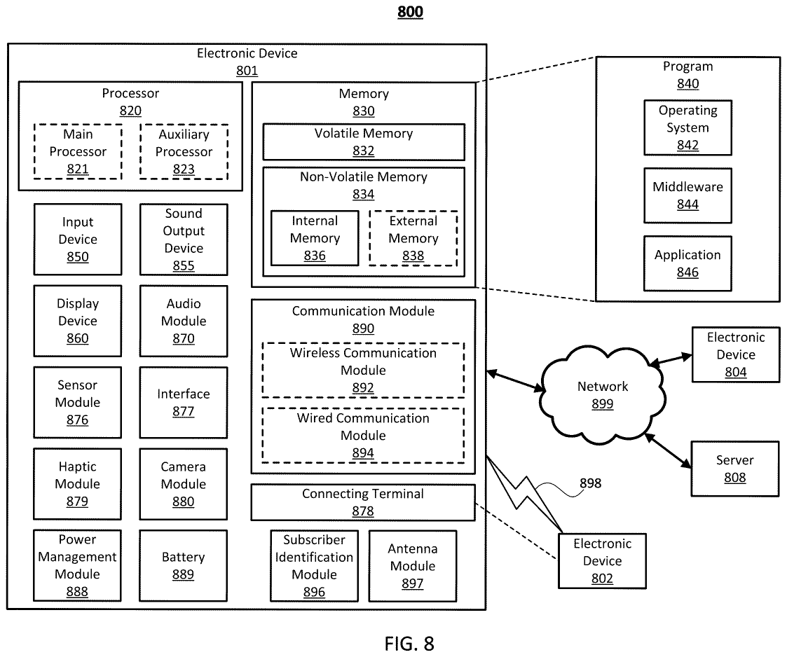

FIG. 8 is a block diagram of an electronic device in a network environment, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations.

The electronic device 801 depicted in FIG. 8 may be configured to support the LPM selection techniques described throughout this disclosure. For example, processor 820 may execute the decision logic for dynamic or hybrid LPM entry as described with respect to the flow diagrams in FIGS. 5-7. In such embodiments, the processor 820 may monitor system idleness, maintain statistical logs in memory 830, and apply threshold logic (e.g., Th and ThNo) to determine whether to trigger entry into various LPM states. The power management module 888 may coordinate transitions into and out of LPM, ensuring that performance targets and energy efficiency constraints are balanced during operation.

The memory 830 may store the circular buffer and associated statistical counters used in the LPM control algorithms. For instance, the buffer managed by circular buffer manager 408 in FIG. 4B may be implemented within memory 830, and continuously updated based on activity detected by the processor 820 or sensor module 876. The power management module 888 and battery 889 may further be integrated with control logic such as the LPM decision tracker 409 or the performance tracker 410 to adjust thresholds dynamically in accordance with real-time performance observations, thereby extending battery life without compromising responsiveness.

In addition, the communication module 890 may be a significant consumer of power and may therefore be a target for the described LPM control logic. For example, in idle radio listening states or when uplink/downlink activity is low, the processor 820 may determine, based on historical idle slot patterns, whether to place the communication module 890 or its interface 877 into one of several low power states. Entry and exit latencies, as tracked by breakeven window timer 407 or hysteresis timer 402, may be factored into these decisions to optimize energy usage based on recent traffic patterns.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834.

The processor 820 may include a main processor 821 (e.g., a CPU or an application processor (AP)), and an auxiliary processor 823 (e.g., a GPU or ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication.

The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for managing low power mode (LPM) transitions in a processing system, the method comprising:
detecting at least one idle state of the system over a plurality of timeslots to generate a count of idle timeslots;
determining, based on a comparison between the count of idle timeslots and a first threshold value, whether to enter an LPM; and
initiating the LPM in response to the count being greater than or equal to the first threshold value.

2. The method of claim 1, wherein the first threshold value is determined using a Z-test based on at least one of a target confidence level, a probability estimate of the system remaining idle during a timeslot, or a standard deviation calculated from a sample window of the idle timeslots.

3. The method of claim 1, further comprising maintaining a circular buffer storing an indication of whether each timeslot corresponds to the at least one idle state or a non-idle state.

4. The method of claim 1, wherein each timeslot has a fixed duration corresponding to a latency value for entering the LPM.

5. The method of claim 1, wherein the first threshold value is computed based on a target probability, a sample size, or a confidence level.

6. The method of claim 1, further comprising comparing the count of idle timeslots to a second threshold value that is less than the first threshold value, and suppressing entry into the LPM in response to the count being less than the second threshold value.

7. The method of claim 6, further comprising, in response to the count of idle timeslots being between the first threshold value and a second threshold value, initiating the LPM using a hysteresis timer.

8. The method of claim 1, further comprising adjusting the first threshold value during runtime based on a posterior probability distribution derived from idle behavior observed over the plurality of timeslots.

9. The method of claim 1, wherein the LPM is selected from among a plurality of candidate modes, and wherein each candidate mode is associated with a corresponding threshold value.

10. The method of claim 1, further comprising updating a performance metric after exiting the LPM and using the performance metric to refine the first threshold value.

11. A memory device configured to manage low power mode (LPM) transitions, the memory device comprising:
a detection unit configured to detect at least one idle state of the memory device over a plurality of timeslots to generate a count of idle timeslots;
a comparison unit configured to determine, based on a comparison between the count of idle timeslots and a first threshold value, whether to enter an LPM; and
a power management unit configured to initiate the LPM in response to the count being greater than or equal to the first threshold value.

12. The memory device of claim 11, wherein the detection unit is further configured to monitor a processing load or transaction activity on a component of the memory device.

13. The memory device of claim 11, further comprising a circular buffer configured to store an indication of whether each timeslot corresponds to the at least one idle state or a non-idle state.

14. The memory device of claim 11, wherein each timeslot has a fixed duration corresponding to a latency value for entering the LPM.

15. The memory device of claim 11, wherein the comparison unit is further configured to compute the first threshold value based on a target probability, a sample size, or a confidence level.

16. The memory device of claim 11, wherein the comparison unit is further configured to compare the count of idle timeslots to a second threshold value that is less than the first threshold value, and to suppress entry into the LPM in response to the count being less than the second threshold value.

17. The memory device of claim 16, wherein the power management unit is further configured to initiate the LPM using a hysteresis timer in response to the count of idle timeslots being between the first threshold value and a second threshold value.

18. The memory device of claim 11, wherein the comparison unit is further configured to adjust the first threshold value during runtime based on a posterior probability distribution derived from idle behavior observed over the plurality of timeslots.

19. The memory device of claim 11, wherein the power management unit is further configured to select the LPM from among a plurality of candidate modes, each candidate mode associated with a corresponding threshold value.

20. The memory device of claim 11, wherein the power management unit is further configured to update a performance metric after exiting the LPM and to refine the first threshold value based on the performance metric.
